(19) United States
(12) Patent Application Publication
(10) Pub. No.: US 2026/0290176 A1
(43) Pub. Date: Sep. 24, 2026

(54) FOUR DIMENSIONAL GEOSPATIAL SYSTEMS AND METHODS FOR AIRCRAFT FLIGHT PLANNING

(71) Applicant: NEARMISSTRACKER, LLC, Sunrise, FL (US)

(72) Inventor: Atal Bansal, Sunrise, FL (US)

(21) Appl. No.: 19/571,887

(22) Filed: Mar. 19, 2026

Related U.S. Application Data
(60) Provisional application No. 63/775,713, filed on Mar. 21, 2025.
(60) Provisional application No. 63/775,730, filed on Mar. 21, 2025.

(51) Int. Cl. G08G 5/59; G08G 5/23; G08G 5/56

(52) U.S. Cl. CPC G08G 5/59; G08G 5/23; G08G 5/56

(57) ABSTRACT

Four dimensional geospatial systems and methods for aircraft flight planning. A coordination system can receive and analyze multiple four dimensional flight paths. The flight paths may include, each as a function of time, the latitude, longitude, and altitude over a complete flight path from start to end. Indicators of risk may be generated based on comparison of multiple such flight plans. Risk may be based on maintaining a minimum separation in flight between all aircraft and compliance to flight path. A user may input a proposed flight plan into a user device. The user device may provide the proposed flight plan for analysis to the coordination system, which may approve or reject the plan. An air traffic monitor may receive a visual display of real-time aircraft indicators of collision risk for multiple aircraft. The indicators may be visual alerts, such as color-coded bubbles over each aircraft, and/or audible alerts.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. For example, this application claims priority to U.S. Provisional Application No. 63/775713, filed Mar. 21, 2025, titled FOUR DIMENSIONAL GEOSPATIAL SYSTEMS AND METHODS FOR AIRCRAFT FLIGHT PLANNING, and to U.S. Provisional Application No. 63/775730, filed Mar. 21, 2025, titled FOUR DIMENSIONAL GEOSPATIAL SYSTEMS AND METHODS FOR AIRCRAFT FLIGHT PLANNING, the entire contents of each of the foregoing applications is hereby incorporated by reference herein and forms a part of this specification for all purposes.

### BACKGROUND

### Field

This disclosure relates generally to aircraft traffic, in particular to planning, safety, and monitoring aircraft flight plans in four dimensions, for example for use in an aircraft collision avoidance system.

### Description

Aircraft collisions and near misses of aircraft are becoming more common as air traffic increases. Conventional air traffic control (ATC) systems rely on a network of radar systems, communication towers, and satellite technologies to determine aircraft movements and to actively provide instructions to pilots for plane takeoff, cruise, and landing. Further, such interactions rely heavily on real-time human communication, interpretation, and decision making by both the controllers and the pilots. Such systems are designed to actively guide the movement of aircraft to ensure safe and efficient travel through the air. Air traffic controllers are stationed at various communication towers and airports across the country to ensure pilots are provided with the information they need to reach their destination. This information is intended to provide safe distances between aircraft near airports. To make sure the pilots have up-to-date information, the air traffic controllers provide clearance for pilots to take off and land. The air traffic controllers and air traffic systems are critical for maintaining aviation safety, preventing accidents, and facilitating smooth operations in the sky.

However, the processes, protocols, planning, and the underlying radar technology and infrastructure used by air traffic controllers and pilots are outdated, inefficient, and can limit real-time information sharing. Since air traffic controllers are required to maintain constant communication with pilots and manage the coordination of multiple flights simultaneously, the accuracy of the instructions provided by the air-traffic controller are critical for aircraft safety. For example, if the air traffic controller is issuing instructions (e.g., vectors) to pilots in crowded airspaces with rudimentary directions based on inaccurate radar systems or outdated aviation charts, there is a greater chance of near-miss incidents, mid-air collisions, and/or other serious safety issues that can occur. Further, some airports are very crowded and reliance on human visual control of the traffic presents risks to aviation and passenger safety. Additionally, many airports are untowered and rely on pilot-to-pilot communication due to the absence of any Air Traffic Controllers. There may also be controlled or uncontrolled airspace in which aircraft operators (e.g., in-flight, remote, autonomous) may be unable to communicate with operators.

Air traffic is growing and new aircraft (e.g., drones, VTOLs) are occupying the airspace as well. There is a growing need for improvements to air traffic control systems and methods.

### SUMMARY

The disclosure herein presents various embodiments for aircraft collision avoidance systems and methods.

In some examples disclosed herein an air traffic monitoring system is disclosed. The air traffic monitoring system may include monitoring devices on the aircraft or remote. The air traffic monitoring system may include one or more memories storing instructions thereon. The air traffic monitoring system may include one or more processors in communication with the air traffic monitor device and one or more memories. The one or more processors may be configured to execute the instructions and may thereby cause the air traffic monitor device to detect or receive aircrafts or flight paths for multiple aircraft. Each flight path may include a starting point, an ending point, and one or more segments connecting the starting point to the ending point, with each segment of the one or more segments identified temporally in four dimensions by latitude, longitude, altitude, and time. The one or more processors may be configured to cause the air traffic monitor device to transmit the flight paths to a coordination system. The coordination system may include a computational component configured to receive, process, and store data based on the flight paths. The one or more processors may be configured to cause the air traffic monitor device to generate four-dimensional stay-out zones for each aircraft of the multiple aircraft along the respective flight path. The one or more processors may be configured to cause the air traffic monitor device to compare the stay-out zones for the flight paths over time. The one or more processors may be configured to cause the air traffic monitor device to determine an expected minimum separation between two or more of the stay-out zones. The one or more processors may be configured to cause the air traffic monitor device to generate indications of risk based on the expected minimum separation. The one or more processes may be configured to generate indications of compliance based on an acceptable margin of error of the respective flight path.

In some examples disclosed herein, the indications of risk may include visual displays. In some examples, the visual displays may be a bubble surrounding the multiple aircraft. In some examples disclosed herein, the visual displays may be color-coded.

In some examples disclosed herein, the indications of risk may include audible alerts.

In some examples disclosed herein, the indications of risk are an indication or risk of compliance. The indication of risk of compliance may be a first color when the expected minimum separation is above a first threshold, the indications of risk of compliance may be a second color for medium risk when the expected minimum separation is below the first threshold and above a second threshold, and the indications of risk of compliance may be a third color when the expected minimum separation is below the second threshold.

In some examples disclosed herein, the indication of compliance may include a first level indication conveying an aircraft of the multiple aircraft is following a prescribed flight path within an acceptable margin of error or that the aircraft is not at risk of a near-miss with another aircraft. In some examples disclosed herein, the indications of compliance of collision may include a second level risk indication conveying the aircraft has deviated from the prescribed flight path beyond the acceptable margin of error but within a maximum allowable margin of error or that the aircraft is at risk of a near-miss with another aircraft. In some examples disclosed herein, the indications of compliance may include a third level risk indication conveying that the aircraft has deviated from the prescribed flight path beyond the maximum allowable margin of error or that the aircraft is at high risk of collision with another aircraft.

In some examples disclosed herein, a method of monitoring air traffic is disclosed. The method may include receiving flight paths for multiple aircraft. Each flight path may include a starting point, an ending point, and multiple segments connecting the starting point to the ending point, with each segment identified temporally in four dimensions by latitude, longitude, altitude, and time. The method may include transmitting the flight paths to a coordination system. The coordination system may include a computational component configured to receive, process, and store data based on the flight paths. The method may include generating stay-out zones for each aircraft along the respective flight path. The method may include comparing the stay-out zones for the flight paths over time. The method may include determining an expected minimum separation between two or more of the stay-out zones. The method may include generating indications of risk of collision based on the expected minimum separation.

In some examples disclosed herein, the method may further include receiving the flight paths in a natural language.

In some examples disclosed herein, the method may further include delivering the flight paths to an AI agent, the AI agent may be configured to generate and transmit flight path information to the coordination system.

In some examples disclosed herein, the coordination system may include a large language model (“LLM”).

In some examples disclosed herein, the method may further include rejecting a flight path if the expected minimum separation between a respective aircraft and another aircraft of the multiple aircraft is below a minimum threshold.

In some examples disclosed herein, the method may include generating indications of compliance to the flight paths. The indications of compliance may include a first level indication conveying an aircraft of the multiple aircraft is following a prescribed flight path within an acceptable margin of error or that the aircraft is not at risk of a near-miss with another aircraft. In some examples disclosed herein, the indications of compliance may include a second level risk indication conveying the aircraft has deviated from the prescribed flight path beyond the acceptable margin of error but within a maximum allowable margin of error or that the aircraft is at risk of a near-miss with another aircraft. In some examples disclosed herein, the indications of compliance may include a third level risk indication conveying that the aircraft has deviated from the prescribed flight path beyond the maximum allowable margin of error or that the aircraft is at high risk of collision with another aircraft.

In some examples disclosed herein, the indications of risk may include visual displays. In some examples disclosed herein, the visual displays may include a bubble surrounding the multiple aircraft, wherein the bubble is color-coded. In some examples disclosed herein, the indications of risk may include audible alerts.

In some examples disclosed herein, a user device for use with an air traffic monitoring system may include one or more processors and one or more memories storing instructions thereon. The one or more processors and one or more memories, when executed by the one or more processors, may cause a method of generating a four dimensional geospatial flight path. The method may include receiving flight data at the user device. The method may include generating a proposed flight path based on the flight data. The proposed flight path may include the four dimensional geospatial flight path including latitude, longitude and altitude as a function of time. The method may include transmitting the proposed flight path to a coordination system of the air traffic monitoring system. The method may include receiving a notification from the coordination system that the proposed flight path was rejected or accepted.

In some examples disclosed herein, the method may further include, in response to receiving the notification that the proposed flight path was rejected, receiving second flight data at the user device and generating a new proposed flight path based on the second flight data.

In some examples disclosed herein, the method may further include, in response to receiving the notification that the proposed flight path was accepted, receiving a tracking of aircraft relative to an accepted flight path.

In some examples disclosed herein, the notification from the coordination system that the proposed flight path was rejected or accepted may be based on analysis of the four dimensional geospatial flight path of the proposed flight path and one or more other four dimensional geospatial flight paths of one or more other aircraft.

### BRIEF DESCRIPTION OF THE DRAWINGS

The foregoing and other features, aspects, and advantages of the present disclosure are described in detail below with reference to the drawings of various embodiments, which are intended to illustrate and not to limit the disclosure. The drawings comprise the following figures in which:

FIGS. 1A, 1B, 1C, and 1D illustrate flow diagrams of example methods for creating, analyzing, and monitoring aircraft flight paths according to the present disclosure.

FIGS. 2A and 2B are example flight paths visualized in 3-D that may be created and analyzed according to various methods of the present disclosure.

FIG. 3 is a schematic illustrating an embodiment of a system for creating, analyzing, and monitoring aircraft flight paths that may be used with any of the methods described herein.

FIG. 4 illustrates a schematic of an embodiment of a coordination system that may be used in the system of FIG. 3.

FIG. 5 illustrates a flow diagram of an example method for a user to generate a flight path using the coordination system of FIG. 4.

FIG. 6 illustrates a schematic of an embodiment of a computing system which may implement one or more components of the coordination system of FIG. 4.

FIG. 7 illustrates an embodiment of a visual display of a planning mode that may be used by the various systems and methods described herein.

FIG. 8 illustrates an embodiment of a visual display in a simulation mode that may be used by the various systems and methods described herein.

FIG. 9 illustrates an embodiment of a visual display of indications of risk of collision that may be used by the various systems and methods described herein.

FIG. 10 illustrates an embodiment of a visual display of risk of collision for a particular aircraft that may be used by the various systems and methods described herein.

FIG. 11 illustrates an example of a visual display for a user to input a flight path.

FIGS. 12A and 12B illustrate flow diagrams of embodiments of methods for identifying potential near-miss events between aircraft.

### DETAILED DESCRIPTION

Although embodiments, examples, and illustrations are disclosed below, the disclosure described herein extends beyond the specifically disclosed embodiments, examples, and illustrations and includes other uses of the disclosure and obvious modifications and equivalents thereof. Embodiments of the disclosure are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the disclosure. In addition, embodiments of the disclosure may comprise several novel features, and no single feature is solely responsible for its desirable attributes or is essential to practicing the disclosures herein described unless otherwise indicated as such.

The disclosure herein relates to a four-dimensional geospatial platform for aircraft flight planning. “Flight planning” can include determining a flight path for the aircraft in four dimensions, as further described. The flight path may include one or more segments of an entire flight. The segment may be from take-off to landing, or between any two points through the flight and is not required to be an entire flight (e.g., from take-off to landing). The platform may be used for aircraft collision avoidance systems and aircraft navigation aids for use by pilots and air traffic monitors. Air traffic “monitors” using the systems described herein may replace air traffic “controllers” because the systems and methods according to the present disclosure allow for mere monitoring and selective interaction with only pilots in aircraft at risk, as opposed to the conventional systems which require active guidance and constant communication with all aircraft in and around airports. The systems according to the present disclosure may generate three-dimensional geospatial coordinates over time (thus four dimensions) for aircrafts to follow and for the system to analyze. Once a flight path is generated, it is compared with other flight paths being followed in the region. If the generated flight path is not expected to violate an airspace restriction and a minimum distance threshold with another aircraft and is expected to avoid a near-miss situation, then the flight path is cleared. Otherwise, the flight path is rejected and a new flight path must be generated. All generated flight paths may be sent from the pilot to the platform for final approval.

Use of the platform for avoiding aircraft collisions and near-miss incidents may include pilots inputting into a system (e.g., control system, CPU, processor, artificial intelligence (“AI”) agent or other digital agent) a proposed flight path (e.g., from take-off to landing, from two distinct points along the flight, between towers, a landing segment, etc.). The platform may prevent aircraft collisions between fixed-wing aircraft, airliners, business jets, turboprops, helicopters, general aviation piston aircraft, vertical take-off and landing aircraft (VTOLs), unmanned aircraft systems (UAS), drones, hot air balloons, or the like. Pilots (or aircraft operators) may be on the aircraft or may operate the aircraft remotely or may be computer programs (autonomous). In some examples, the aircraft may be autonomous. Each flight plan or flight path may include a starting point, an ending point, and multiple segments connecting the starting point to the end point, with each segment identified temporally in four dimensions by latitude, longitude, altitude, and time. The flight path may be a segment of a flight (e.g., from a tower to landing, between towers, between two distinct locations, portion defined by a pilot) and not an entire flight (e.g., from take-off to landing). The flight path may also be an entire flight (e.g., from take-off to landing). After inputting the proposed flight path, the system may include one or more modes. The system may have three modes, including a simulation mode, a planning mode, and a flight mode. The simulation mode can include simulating or proposing a flight path in light of other current flight paths for virtual analysis. The planning mode can include determining whether the simulated/proposed plan/path is acceptable. The flight mode can include displaying the accepted flight path and generating an indicator (e.g., a color-coded bubble) on a display screen for the air traffic monitor to view and monitor. These and other features will be more fully described in particular examples with respect to the figures.

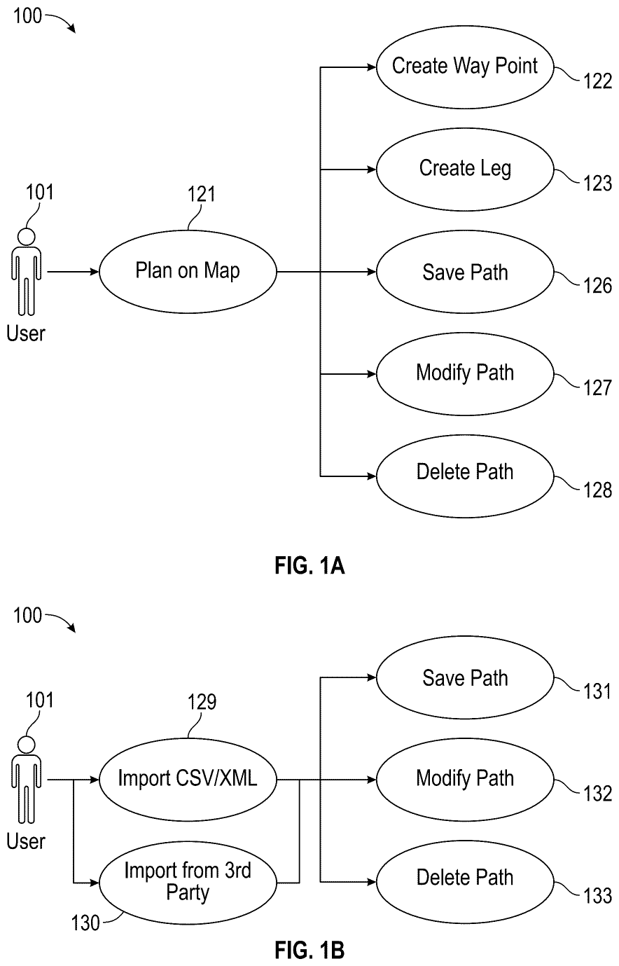

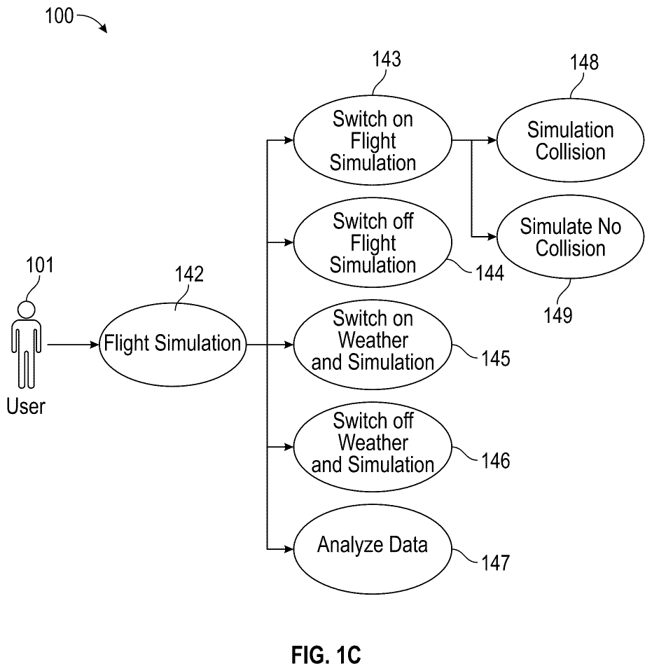

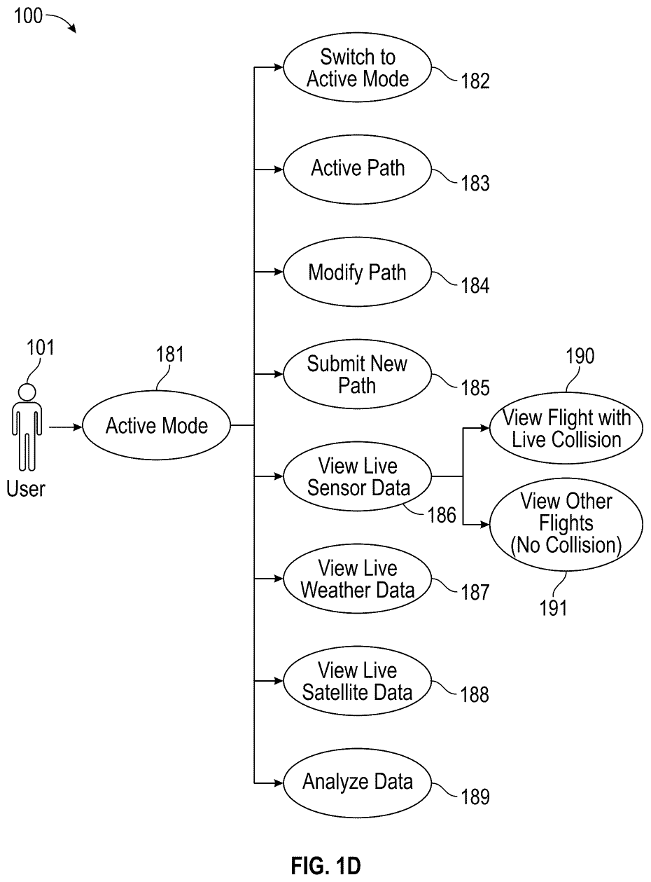

FIG. 1A shows a flow diagram of an example method for a user to generate a flight path or flight plan using an aircraft avoidance system 100 (e.g., an aircraft collision avoidance system). The aircraft avoidance system 100 may check for collision data based on flight paths submitted to the system. The method may begin at block 121. At block 121, a user 101 (e.g., a pilot, an AI agent, a digital agent) may submit a path or plan on a virtual display or virtual map. The flight path or flight plan may be submitted at discrete steps along the entire flight (e.g., a partial landing segment, between towers). The user may submit multiple flight paths during the duration of the flight. From block 121, the method may proceed to any other blocks shown in FIG. 1A. At block 122, the user may create a point on the map based on a geographical coordinate. The point or waypoint may also be created based on navigational data. The navigational data may be based on airports, helipads, landmarks, or other data provided by the National Airspace System Resource (NASR). The user may also delete the points or waypoints submitted at block 122. At block 123, the user may create a leg based on multiple waypoints (e.g., two, three, or four) positioned on the map. Additionally, the user may input leg (e.g., flight leg) parameters (e.g., climbing parameters, descending parameters, cruise parameters). The leg parameters may include starting date and time, starting location (e.g., starting geo-location), ending location (e.g., ending geo-location), ground speed, ground distance, heading, starting altitude, vertical speed, and/or ending altitude.

At block 126, the user may save and/or submit the flight path. The saved and/or submitted flight path may be analyzed and/or delivered to an air traffic monitor. At block 127, the user, the air traffic monitor, or the computer analysis software may modify the flight path. The flight path may be modified by changing the waypoints submitted at block 122 or by modifying the leg parameters submitted at block 123. At block 128, the user may delete the flight path. The flight path may be deleted based on input from the air traffic monitor (e.g., dangerous flight conditions, crowded or restricted airspace, flight path conflict, or the like).

FIG. 1B shows another flow diagram of an example method for a user to generate a flight plan with the aircraft avoidance system 100. The method may begin at block 129 or block 130. At block 129, a user 101 or AI agent may import a flight path (that includes waypoints and legs) instead of planning the route on a map. The method may proceed to any other blocks shown in FIG. 1B. At block 130, the user may import the flight path from a third party (e.g., the ATC's preferred IFR routes, fuel-efficient routes, expert routes). From blocks 129 or 130, the method may proceed to any other blocks shown in FIG. 1B. At block 131, the user may save and submit the flight path. The saved and submitted flight path or flight plan may be delivered to an air traffic monitor device or system. At block 132, the user or a third party or system may modify the flight path. The path may be modified by changing waypoints or legs of the flight path submitted at block 129 or block 130. At block 133, the user may delete the flight path. The flight path may be deleted based on input from the air traffic monitor (e.g., dangerous flight conditions).

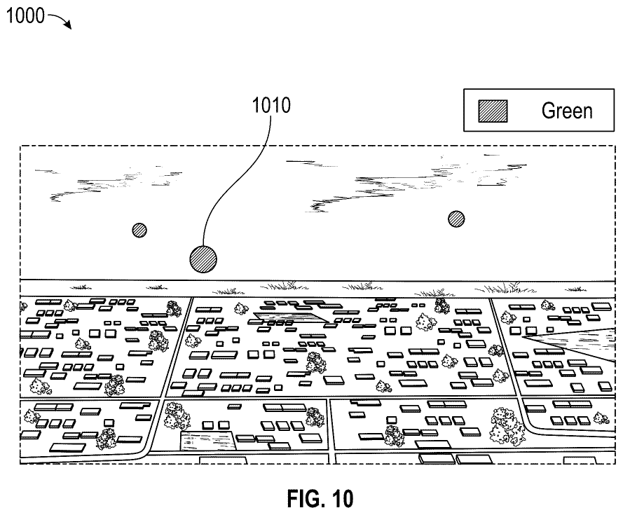

FIG. 1C shows another flow diagram of an example method for a user to simulate a flight path with the aircraft avoidance system 100. The method begins at block 142. At block 142, the user 101 or AI agent may simulate and visualize the flight path and other flights based on the planned route (e.g., flight paths submitted at block 126 and/or block 131). The submitted flight path may be a realistic preview of the flight path, may include navigation aids, and may include environmental conditions. From block 142, the method may proceed to any other block shown in FIG. 1C. At block 143, the user may turn on the flight simulation (e.g., the user may toggle to the simulation of the flight). At block 148, the user may simulate the flight path to determine potential collision information. The simulation of the collisions at block 148 may show an aircraft on the flight path having a bubble (e.g., a “safety bubble”) or other zone as described herein surrounding the aircraft. The bubble may be color-coded to display information as further described and as shown, for example, in FIGS. 9 and 10. For example, the bubble may be a first color, a second color, or a third color, such as green, yellow, or red, respectively. If the generated bubble is green, the aircraft may be following or flying along the correct flight path, be on time, and not be at risk of a near miss or collision. If the generated bubble is yellow, the aircraft may be slightly off the correct path, such as slightly ahead/behind schedule, or is at risk of a near miss. If the generated bubble is red, the aircraft is far off the correct path (e.g., generated/submitted/approved plan) and/or far ahead/behind schedule, and/or is in serious risk of a collision. For example, if the aircraft is beyond a threshold time, for instance, at least 5 minutes, at least 10 minutes, or at least 20 minutes, or other times, off track, the bubble may change color from green to yellow, green to red, yellow to red, etc. Additionally, if the aircraft is beyond a threshold distance, for example, 1 mile, 2 miles, 4 miles, or other distances, from its expected location (e.g., latitude, longitude, or altitude), then the bubble may change color (e.g., green to yellow, green to red, yellow to green, etc.). Additionally, the size of the bubble may provide information to the user. The size of the bubble may indicate the type or size of the aircraft (e.g., larger aircraft have larger bubbles, smaller aircraft have smaller bubbles). For example, a commercial airliner may have a larger bubble than a drone. In some implementations, the size of the bubble is configurable (e.g., based on aircraft type, mission, and/or the like), but is fixed for the duration of a flight. In some implementations, however, the size of the bubble may be configured to be changeable during a flight. For example, the size of the bubble may be based on the weather. For example, during bad weather conditions, the size of the bubble may increase and during clear weather conditions, the size of the bubble may decrease. The size of the bubble may be related to the mission or flight type (e.g., private, military, commercial). For example, the bubble surrounding a military aircraft may be larger than the bubble surrounding a drone or a private aircraft. In some implementations, the size of the bubble may remain the same size during the submitted flight path. In some implementations, the size of the bubble may change if a different flight path is submitted and flight conditions change (e.g., flight type, weather conditions).

At block 149, the aircraft may simulate no collision and be shown without any collision data. The aircrafts displayed (e.g., via a display screen) may not have any generated bubbles surrounding them or only green bubbles. At block 144, the flight simulation may be toggled off. At block 145, a weather system and satellite may be turned on. The weather system and satellite may provide real-time weather information along the flight route. Additionally, the weather system may provide any alerts or notifications about dangerous air or weather conditions. At block 146, the weather system and satellite may be toggled off.

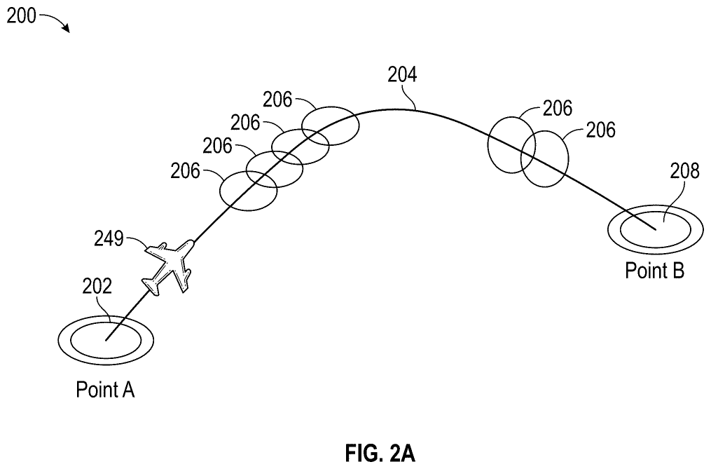

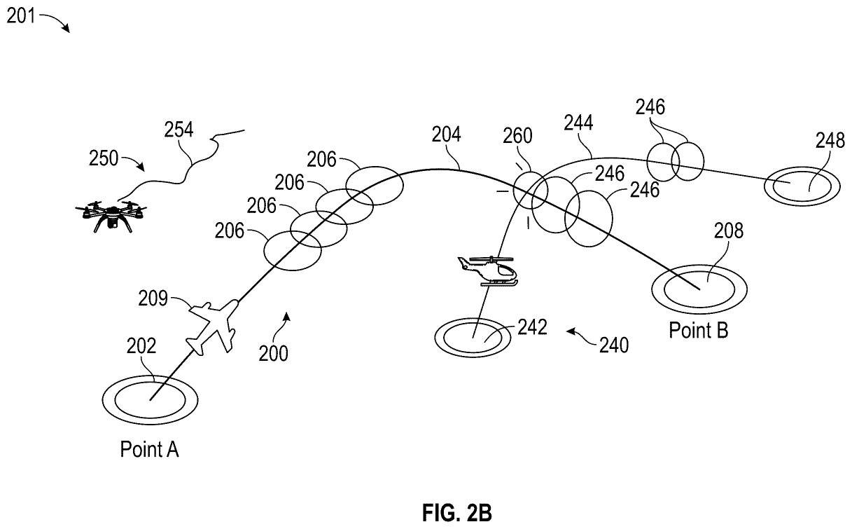

At block 147, the data generated (e.g., data generated at block 142) may be analyzed. The data analyzed may include the possible flight scenarios and may detect whether the aircraft may collide during the proposed flight path (e.g., flight path submitted at block 126 and/or block 131). The data analyzed will be described further below in FIGS. 2A-2B, 4, and 5.

FIG. 1D shows another flow diagram of an example method for a user or analysis system to use a flight path with the aircraft avoidance system 100. If the flight path is approved by the collision tracker and the air traffic monitor, then the user (e.g., pilot, or AI agent), autonomous aircraft, or system may begin to fly along the approved route (e.g., along the route submitted at block 126 and/or 131). At block 181, an active mode may be enabled, and the user, autonomous aircraft, or system may begin to travel using the approved (e.g., by the aircraft avoidance system 100) flight path. From block 181, the method may proceed to any other block shown in FIG. 1D. At block 182, the user, autonomous aircraft, or system may switch from the previous screen (e.g., block 142, a simulation screen, a preview of the flight path) to use the active mode. At block 183, the user or system may proceed by using the flight path that has been approved by the aircraft avoidance system 100 and the air traffic monitor. At block 184, the user or system may change or modify the flight path if they determine that the flight path is no longer safe or desirable. For example, if the user or system determines that an unforeseen weather condition has made the flight path less tenable, then the user or system may modify a leg or waypoint of the flight path. At block 185, the user or system may determine that they need to submit a new flight path if the flight path needs to be changed due to an unexpected condition (e.g., an airport is shut down and the pilot needs to travel to a new or nearby airport), crowded airspace, or another aircraft has significantly deviated from their flight path.

At block 186, the user or system may view the live air traffic. For example, the user or system may view sensor (e.g. ADS-B) data (e.g., aircraft identification information, GPS position, latitude, longitude, altitude, ground speed, vertical trend). The live air traffic may be a result of numerous aircraft transmitting sensor (e.g. ADS-B) data out. At block 190, the user or system may view the live air traffic with the collision information. For example, the live air traffic may show aircraft along on the flight path having a bubble surrounding the aircraft (described further in FIGS. 2A, 4, and 5). The bubble may be color-coded (e.g., green, yellow, or red) to show how far off their designated flight path the respective aircraft is, as described. The live air traffic may show aircrafts compliance with their respective flight path (e.g., a color code based on whether the aircraft is complying with its flight path). At block 191, the user or system may toggle off the view of other aircraft (e.g., stop viewing live air traffic from block 190).

At block 187, the user or system may view live weather data. At block 188, the user or system may view satellite data. At block 189, the data generated (e.g., data generated at block 181 or viewed with block 190) may be analyzed. The data analyzed may include the possible flight scenarios and may detect whether the aircraft may collide during the proposed flight path (e.g., flight paths submitted at block 126 and/or block 131). The data analyzed is described in further detail herein, for example, with respect to FIGS. 2A, 2B, 4, and 5.

FIG. 2A is an illustration of a visualization of an example flight plan or flight path 200 (e.g., an approved flight path) submitted to or shown by the system (e.g., aircraft avoidance system 100). The flight path 200 may include a beginning point 202 (e.g., a first point, point A) and an end point 208 (e.g., a second point, point B). The pilot or autonomous vehicle may follow a path 204 which starts at beginning point 202 and ends at end point 208. Along the path 204, a safety bubble or bubble 206 may be generated. The bubble (which may be a “safe zone” for the aircraft) 206 may be iteratively generated at points along the path 204. The path 204 generated may be based on latitude, longitude, altitude, and time (e.g., block 126). Each bubble 206 along the path 204 may be generated at intervals spanning ten seconds or other time intervals (e.g., the position the aircraft is between beginning point 202 and path 204 spaced ten seconds apart). Each bubble 206 may be based on three-dimensional geospatial coordinates over time (thus four dimensions). In other words, each bubble (or safe zone) gets generated in 3D and “released” over time. That is, the safe zone may only “lock” a 3D space zone for that moment of time.

As noted above, the bubble 206 may be a fixed size that is sized based on, for example, the size of the aircraft. For example, if the aircraft is larger (e.g., a commercial plane, passenger capacity of 150+, wingspan of 150 feet, takeoff weight of approximately 300,000 lbs.), the size of the bubble 206 may be larger. If the aircraft is smaller (e.g., passenger capacity of approximately 9 people, wingspan of approximately 50 feet, takeoff weight of approximately 12,500 lbs.), the size of the bubble 206 may be smaller. As also noted above, however, in some implementations, the size of the bubble may be variable during a flight path. For example, the bubble 206 may be larger if an aircraft 209 has deviated farther away from the flight path 200. If the aircraft 209 is approximately ten minutes away from its expected location, then the bubble 206 may be larger. Additionally, the bubble 206 may be larger if the location of the aircraft 209 has deviated far away from its expected location on the flight path 200 (e.g., approximately 2 miles off of the desired location). In some examples, the larger the size of the bubble 206, the more likely aircraft 209 ger the size of the bubble 206 the more likely aircraft 209 is to collide with another aircraft (e.g., aircraft 249, see FIG. 2B for reference).

The bubble 206 may be sized based on the weather conditions. For example, the bubble 206 may be larger if there are poor conditions/visibility (e.g., cloudy, stormy, high winds) in order to reduce the chances of aircraft collisions. The bubble 206 may be larger if there are two or more aircraft (e.g., a large aircraft and a small aircraft) in the aircraft zone 201. For example, wake turbulence caused by a large aircraft may cause airflow disturbances and hazardous conditions for smaller aircraft flying nearby. The bubble 206 may increase in size around a smaller aircraft (e.g., a light aircraft, a UAS, etc.) and/or larger aircraft (e.g., a large commercial plane) when the distance between the two aircraft in the aircraft zone 201 is determined to be hazardous (e.g., within at least 0.5 miles, within at least 1 mile, within at least 2 miles, within at least 5 miles). The bubble 206 of an aircraft may also increase due to the presence of an unmanned aircraft in the aircraft zone 201 and/or near the aircraft.

FIG. 2B is an illustration of an example visualization of an aircraft zone 201 where multiple flight plans or multiple flight paths are being followed. The flight path 200 is being followed, along with a second flight path 240 and a third flight path 250. The second flight path 240 may follow a second path 244. The third flight path 250 may follow a third path 254. Although only three flight paths or paths are shown, any number of flight paths (e.g., at least two, at least ten, at least twenty, at least one hundred, at least two hundred, or more) may be in the aircraft zone 201. The second flight path 240 may have a start point 242 (e.g., a first point) and an end point 248 (e.g., a second point). The aircraft 249 may follow a second path 244 between the start point 242 and the end point 248. One or more bubbles 246 may be generated (e.g., similar to bubble 206) along the second path 244. The bubbles 246 may be sized based on weather conditions. The bubbles 246 may be sized based on the overall size and/or distance between aircraft (e.g., between aircraft 209 and aircraft 249). If the aircraft 209 is flying on an approved flight path 200, then other aircraft (e.g., aircraft 249) will not be approved to fly on that path if any of the bubbles 206 are calculated to hit another bubble (e.g., bubbles 246) along its projected flight path (e.g., second path 244) or come within a threshold distance of each other. For example, the second flight path 240 may not be approved by the system (e.g., system 100 or as described further herein) if a collision 260 is detected. The bubbles may be four dimensional (e.g., 4-D). The bubbles may be locked for only a moment in time (e.g., past, present, or future time, within the set time threshold). The collision 260 is calculated based on the path 204 of the flight path 200 (e.g., approved flight path) occupying the same four-dimensional space (e.g., altitude, longitude, latitude, time) as the submitted second flight path 240 (e.g., not approved flight path) or being less than a designated safety margin or threshold. If a collision 260 or violation of the threshold is detected, the second flight path 240 will have to be resubmitted (e.g., block 131) for further submission and approval.

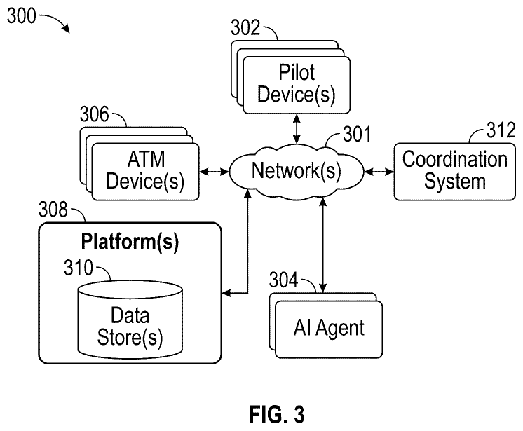

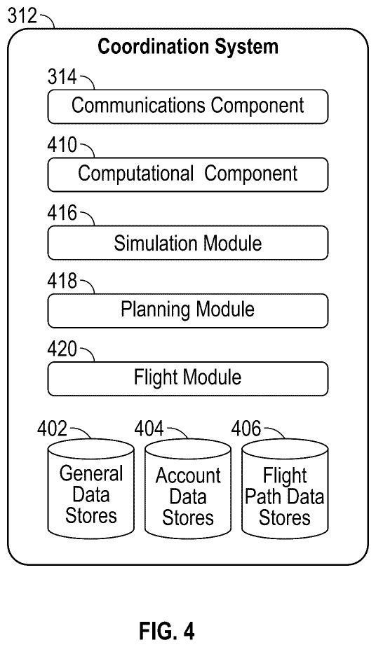

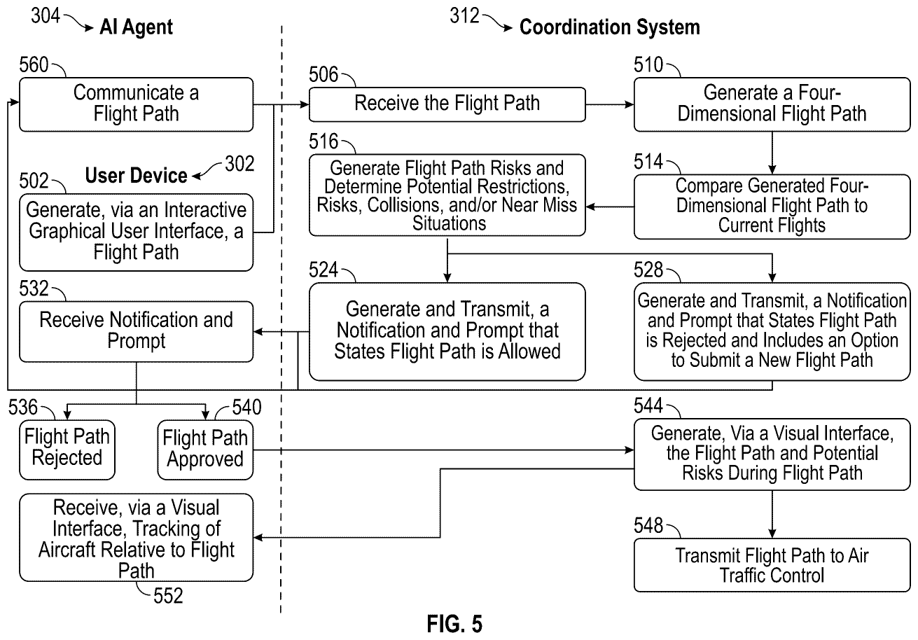

FIG. 3 is a schematic illustrating an embodiment of a system 300 for creating, analyzing, and/or monitoring aircraft flight plans or flight paths. The system 300 may be used for avoiding aircraft collisions and near-miss incidents. The system 300 may include one or more user devices such as one or more pilot devices 302, a digital agent 304, which may be an artificial intelligence (AI) or other agent, one or more air traffic monitor (ATM) devices 306, and/or one or more platforms 308 with data stores 310 in communication over a network 301 with a coordination system 312 (e.g., aircraft collision avoidance system). The coordination system 312 may include one or more subsystems and/or components. Embodiments of the coordination system are further described with reference to FIGS. 4 and 5. The one or more pilot devices 302, the digital agent 304, the one or more air traffic monitor devices 306, the platform(s) 308, and/or the coordination system 312 may include or be in communication with one or more processors configured to execute instructions stored in one or more memories (locally or remotely) to cause various methods of monitoring air traffic to be carried out, including any methods described herein.

In some embodiments, the user devices such as the pilot devices 302 may be a personal computer, a laptop computer, a smartphone, a tablet, a smart watch, a mobile device, a digital agent and/or the like, which can be used by a user to access the coordination system 312 over a network 301. A user (e.g., pilot or digital agent) may access the coordination system 312 to submit a flight path to the platform and/or the like. The coordination system 312 may communicate with the pilot devices 302 through one or more data services such as, for example, an application programming interface (API) or other electronic communication services. The coordination system 312 may communicate with pilot devices 302 to access platforms 308 that are associated with third-party flight paths. In some embodiments, the platforms 308 may include servers or one or more data stores 310. The data stores 310 may store data associated with other pilot flight paths. For example, the data stores 310 may store data related to three-dimensional flight paths as a function of time. The data stores 310 may allow flight paths to be stored without paperwork. The system 300 may allow for the completion of the flight path filing to be quicker and with fewer manual inputs. Example uses of the pilot devices 302 during the flight path submission process are described in further detail with respect to FIG. 5.

The digital agent 304 may communicate (e.g., directly communicate) with a user or operator (e.g., a pilot, controller) of the aircraft (e.g., plane, UAV, drone, helicopter). The digital agent 304 may communicate with the air traffic monitor devices 306 and may communicate directly with a tower (e.g., a human in an air traffic monitor tower at an airport or located remotely from the airport as discussed further herein). The digital agent 304 may receive information (e.g., “take in”, process information) from the user, for example spoken or verbal information or data transmitted otherwise, regarding the flight path, and process such information. For example, the user may relay (e.g., dictate) to the digital agent 304 the starting date and time, starting location (e.g., starting geo-location), ending location (e.g., ending geo-location), ground speed, ground distance, heading, starting altitude, vertical speed, and/or ending altitude of the proposed flight path. The digital agent 304 may create locks or legs (e.g., block 123, leg parameters). The digital agent 304 may relay information (e.g., “read back”) instructions dictated by the pilot or user to the digital agent 304. The digital agent 304 may submit (e.g., transmit, communicate) the flight path to the coordination system 312. The digital agent 304 may send the flight path information to the coordination system 312 via radio (e.g., very high frequency, high frequency, RF communication), internet, satellite, digital networks, or the like. The coordination system 312 may communicate the flight path generated and submitted to the pilot devices 302. The coordination system 312 may communicate the flight path generated and submitted to the air traffic monitor devices 306. The coordination system 312 may generate a visual interface of the flight path, which may be shown on a display of an air traffic monitor or on the pilot devices 302.

In some examples, the digital agent 304 may communicate with the user or operator and instruct the user. For example, the digital agent 304 may use sensor (e.g. ADS-B) data (e.g., block 186) of the plane and may provide flight path instructions to a pilot. The digital agent 304 may detect the date and time, starting location (e.g., starting geo-location), ground speed, ground distance, heading, starting altitude, and/or vertical speed and may provide a flight path for a pilot. The digital agent 304 may then prepare detailed instructions to the pilot about the flight path. For example, the AI agent may state “This is tower at KABC to N1234. I detect your position approximately 5 miles Northeast of the field with the aircraft type CJ100 with an approximate ground speed of 120 Knots. Confirm if accurate; N1234 fly 2 miles northeast to “Bend in the Sawgrass” descending to an altitude of 2000 feet while maintaining an average ground speed of 100 knots. Then fly South for 3 miles to align with Runway 36. Enter traffic pattern at downwind . . . ” The pilot may confirm if they agree to the instructions provided by the digital agent 304. The digital agent 304 may then submit the flight path to the coordination system 312. If rejected by the pilot, the AI agent may then regenerate a flight path for review by the pilot.

The air traffic monitor devices 306 may be a personal computer, a laptop computer, a smartphone, a tablet, smart watch, server, database, mobile device, and/or the like, which can be used to communicate with the coordination system 312 over the network 301. The coordination system 312 may communicate with air traffic monitor devices 306 through one or more data services such as, for example, an application programming interface (API) or other electronic communication services.

The coordination system 312 may communicate with one or more devices (e.g., pilot devices 302, air traffic monitor devices 306, or the like) over the network 301 to facilitate the generation of approved flight paths. An example of the coordination system 312 is described in further detail with reference to FIG. 4.

The network 301 may include one or more networks, including, for example, a local area network (LAN), Radio Frequency (RF), wide area network (WAN), and/or the Internet, for example, via a wired, wireless, radio or combination of wired and wireless, communication links. The network 301 can facilitate communication between the pilot devices 302, the air traffic monitor devices 306, the platforms 308, and the coordination system 312.

FIG. 3 shows an example number of systems in communication with the network 301. There may be any number of the pilot devices 302, air traffic monitor devices 306, and platforms 308 that may be in communication with the one or more networks 301 and the coordination system 312. Further, “multiple” can include, for example, tens, hundreds, thousands, or millions, of systems in communication with the coordination system 312. It is recognized that the devices in communication with the coordination system 312 may be stored in whole or in part on site in a facility or in one or more cloud storage locations. Each of the devices and platforms may include one or more processors in communication with one or more memories storing instructions thereon for execution by the processor(s) to perform various computational tasks.

FIG. 4 illustrates an embodiment of the coordination system 312 and subcomponents. The coordination system 312 may include a communications component 314, a computational component 410, a simulation module 416, a planning module 418, and/or a flight module 420 (e.g., active module). Any of the air traffic monitoring devices and systems described herein may include or be in communication with one or more coordination systems 312.

The communications component 314 may facilitate communication between the coordination system 312 and other systems and devices. For example, the communications component 314 may facilitate communication with pilot devices 302 and the air traffic monitor devices 306. In some embodiments, the communications component 314 may include one or more data input components and one or more data output components, such as a receiver and a transmitter or the like.

In some embodiments, the computational component 410 may be used to implement processes of the coordination system 312. The computational component 410 may include a processor. For example, the computational component 410 may update different elements of the flight path generation process described herein. The computational component 410 may be a control system or an interactive control system. The computational component 410 may include one or more learning systems/models, such as, for example, machine learning, artificial neural networks, language models, decision trees, large language models, artificial intelligence models, and/or the like. The models, (e.g., the large language model (“LLM”)) may be any type of language model that has been trained on a larger data set and has a larger number of training parameters compared to a regular language model. An LLM may understand more intricate patterns (e.g., flight path patterns) and generate text, data, or images (e.g., safety bubbles or flight paths representative of various aircraft in an aircraft zone) that are more coherent and contextually relevant due to its extensive training. An LLM may comprise a neural network trained using self-supervised learning. An LLM may be of any type, including a question answer (“QA”) LLM that may be optimized for generating answers from a context (e.g., a pilot asking and confirming whether a flight path is approved based on input data). The model may generate many combinations of one or more next words or processes that are coherent and contextually relevant. Thus, the computational component 410 may be a language model including an advanced artificial intelligence algorithm that has been trained to understand, generate, and manipulate language in order to generate flight paths. The computational component 410 may be capable of flexible interaction, such as through receiving natural language instructions, with a user.

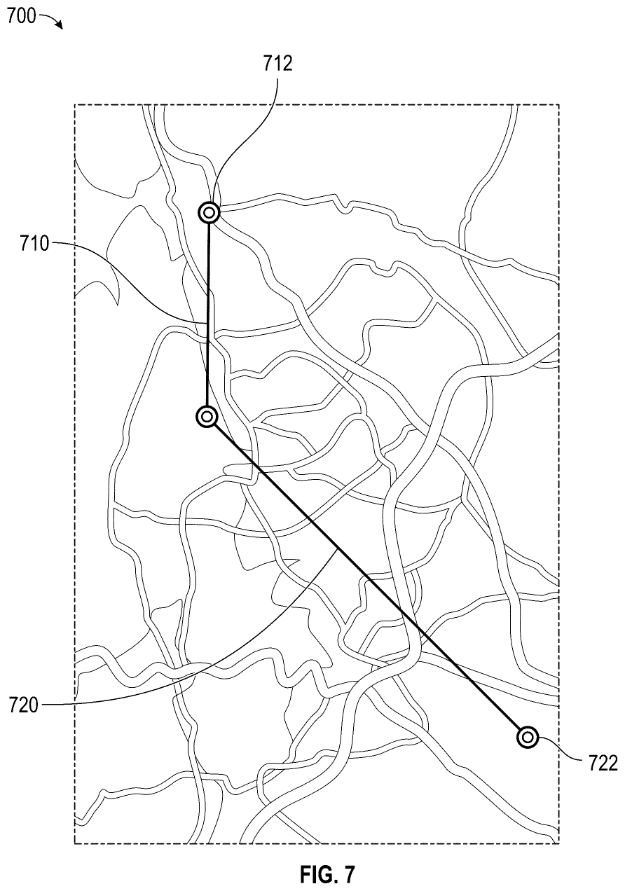

The simulation module 416 may be used to generate and/or analyze a flight plan or flight path, or one or more segments thereof. The simulation module 416 may include inputting multiple data points to generate a flight path. For example, generating a segment of the flight path can include inputting a starting point (e.g., the beginning location of the plane), an end point (e.g., desired location of the plane), multiple segments therebetween, with each segment including an altitude and a location as a function of time. A first segment of the multiple segments may be generated to represent takeoff and ascent. The first segment may also represent any distance between two points (e.g., a first location or landmark and a second location or landmark). The first segment may also be the first portion of a descent (e.g., the start of a descent to a location or point just before landing). One or more middle segments may include cruise or other flight portions. The one or more middle segments may be any distance between two points (e.g., between locations or landmarks) and which follow the first segment. A final segment may include a descent and landing segment. The final segment may also be any third distance or other distance between two points (e.g., between the descent and landing segment) and which follow the one or more middle segments. Each segment generated may take into account starting date and time, starting location (e.g., starting geo-location), ending location (e.g., ending geo-location), ground speed, ground distance, heading, starting altitude, vertical speed, and/or ending altitude. An example visual representation of the flight segments and the simulation module 416 is described in further detail herein, for example with respect to FIGS. 7-9. The pre-flight visualization provided by the simulation module 416 may assist pilots and may help ensure they travel on a conflict-free journey.

The planning module 418 may be used to determine if a flight plan or a flight path is acceptable. The planning module 418 may include accepting or rejecting the generated flight path generated in the simulation module 416. The flight path can be rejected if another flight path (e.g., due to another plane flying in a similar direction) is determined to be too close (e.g., expected minimum distance between planes violates a minimum distance threshold) to another plane (e.g., near-miss) or if it would cause a collision or if the flight path is through restricted airspace or the like. If the system determines a flight path is not acceptable, a new flight path must be inputted by the operator (e.g., by inputting new data points, communicating with the AI agent, communicating with the digital agent). If the flight path is acceptable, the flight path can be sent to the coordination system for review and approval (flight mode). Once approved, the pilot or operator (e.g., operator of an unmanned aircraft) may begin to fly along the generated plan.

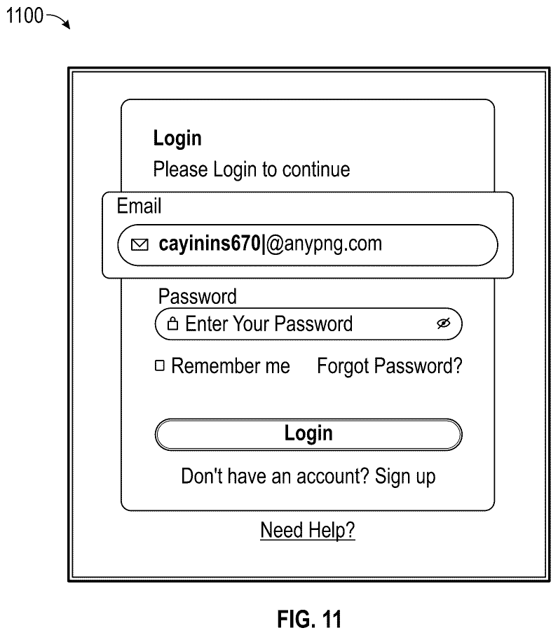

The flight module 420 may be used to assist a pilot, operator, and/or air traffic monitor during flight. The flight module 420 may include generating indicators of stay-out zones, such as bubbles showing spherical stay-out zones of a particular size around each of the aircraft flying in the nearby airspace. The flight module 420 may provide real-time tracking and guidance. The generated bubbles can indicate three sets of information, in some examples by green/yellow/red color, if respectively the aircraft is on a safe flight path and/or following the prescribed flight path within a certain margin of error and not at risk of a near miss, if the aircraft is at risk of a near miss and/or has deviated from the prescribed flight path within a second larger margin of error, or if the aircraft is at risk of collision with another aircraft. For example, if the generated bubble is green or blue, the aircraft may be following the correct flight path and on time and not be at risk of a near miss or collision. If the generated bubble is yellow, the aircraft may be slightly off the correct plan such as slightly ahead/behind schedule or is at risk of a near miss. If the generated bubble is red, the aircraft is far off the correct plan (e.g., generated plan) and/or far ahead/behind schedule, and/or is in serious risk of a collision. FIGS. 9 and 10 show example images of the aircrafts in the airspace with the indicators as color-coded bubbles. A visual representation of the flight module 420 is shown in FIGS. 10 and 11 and described in further detail herein. The generated bubbles help ensure that pilots remain on the correct route and may reduce the chances of in-flight conflicts. The flight module 420 may automatically update the color of the bubbles when the risk of collision has changed due to a flight path deviation. The flight module 420 may reduce time in assisting with flight path deviations and allows air traffic monitors or air traffic controllers to get in contact with a pilot to quickly and seamlessly redirect them to the correct airspace or request assistance.

The coordination system 312 may include a data component or individual data stores that may be configured to control and manage the storage of data within the coordination system 312. For example, the data stores may include, for example, general data stores 402, account data stores 404, flight path data stores 406, and/or the like. The general data stores 402 may be used to store data related to the coordination system 312. For example, the general data store 402 may store data related to system processes, machine learning algorithms, or the like. In some embodiments, the account data store 404 may be used to store data associated with users of the coordination system 312. For example, the account data store 404 may store user profile data, user information, user documents uploaded from the user UI, expertise criteria, user preferred qualification, or the like. In some embodiments, the flight path data stores 406 may be used to store data associated with the pilots who use the coordination system 312. For example, the flight path data stores 406 may store commonly used flight paths used by pilots.

FIG. 5 shows a flow diagram of an example method for a user to generate a flight plan or a flight path using the coordination system 312. There are other embodiments of the method of FIG. 5 which may exclude some of the blocks shown and/or may include additional blocks not shown. Additionally, the blocks discussed may be combined, separated into sub-blocks, and/or rearranged to be completed in a different order and/or in parallel.

At block 502, the user (e.g., pilot) generates a flight path using the pilot devices 302 and transmits the flight path to the coordination system 312. The flight path may be input on an interactive graphical user interface that may be on the pilot devices 302. The information on the flight path input at block 502 may include the starting point of the plan, the end point of the plan (e.g., desired end location of the plane), and the connecting segments that include the latitude, longitude, and altitude as a function of time. The user may input only the beginning and ending points, with the system computing suggested or typical connecting segments therebetween. The user may input the kind of aircraft, or a desired flight time, etc. on which the system may base its suggested segments. The system may access other information, such as weather data, time of day, visibility conditions, etc. and base the suggested plan on such information as well.

At block 506, the coordination system 312 receives the flight path from the pilot devices 302 (or the digital agent 304 as discussed further herein). The flight path may be received by, for example, the communications component 314 and may contain data that may be stored in one or more of the data stores of the coordination system 312. For example, if the flight path request contains user criteria, the data may be stored in account data store 404. Additionally, the flight path data received by the coordination system 312 may be stored in flight path data stores 406. The data stored in flight path data stores 406 may be used in the computational component 410 to help generate future flight paths.

At block 510, the coordination system 312 generates a four-dimensional flight path (latitude, longitude, altitude, time) for the flight path based on the information input by the user at block 502 (or block 560). The coordination system 312 may generate this information at the simulation module 416. At block 514, the coordination system 312 compares the four-dimensional flight path data generated at block 510 with the current flight paths of other aircraft. The other flight paths or flight data may be stored at the platforms 308 and may be transmitted to the coordination system 312. The computational component 410 may compare the four-dimensional flight path generated at block 510 with the other flights and flight paths stored at platforms 308. The computational component 410 may include an LLM or an artificial neural network capable of comparing the four-dimensional flight path generated at block 510 with the other flights and flight paths stored at platforms 308.

At block 516, the risks of the flight path generated at block 502 (or block 560) are generated. Block 516 may include potential restrictions (e.g., temporary airspace restrictions, permanent airspace restrictions, military airspace operation areas, or the like). Block 516 may also determine if any near miss flight situations may occur. The flight path risks may be based on whether another flight path (e.g., due to another plane flying in a similar direction) is determined to be too close to another plane (e.g., near-miss) or if it would cause a collision. This may be based on a particular safety threshold such as a minimum distance by which the aircraft must stay separated. It may be based on aircraft information such as aircraft type and/or aircraft size. The data generated at block 516 may be based on airspace restrictions (e.g., temporary restrictions, permanent airspace restrictions, temporary flight restrictions, military operation areas, restrictions issued by the Federal Aviation Administration (FAA)). The data generated at block 516 may be transmitted to the user. This data can be generated by the coordination system 312 (and the computational component 410) at the planning module 418. At block 524, a notification is generated and transmitted to the pilot devices 302 if the flight path is allowed. At block 528, a notification (or communication) is generated and transmitted to the pilot device 302 or digital agent 304 if the flight path is rejected and displays the option to submit a new flight path. If the communication is generated and sent to the digital agent (block 560), the user may be instructed to resubmit the flight path.

At block 532, the user receives a notification and prompt on the pilot device 302. The notification and prompt will indicate if the flight path was rejected (e.g., block 528). At block 536, if the flight path was rejected, the user must start over and submit a new flight path (e.g., return to block 502). In some embodiments, the system may propose a different flight path. At block 540, if the user had the flight path approved, then the data is transmitted back to the coordination system 312 and the user may begin to fly using the flight path. The approved plan is then input into the system such that future flight paths from other pilots will be analyzed based on this approved flight path. At block 544, the coordination system 312 generates a visual interface of the flight path, which may be shown on a display of an air traffic monitor. The visual interface may show any potential risks that might arise during flying. The visual interface may monitor compliance to a flight path. For example, the visual interface may generate bubbles that may indicate, by green/yellow/red color, as described, or other indicators. The indicators may be based on various information, such as if aircraft are following the correct flight path or if there are any deviations from their correct flight path. If an aircraft is flying too slowly or too fast or has changed latitude, longitude, or altitude in a manner that deviates from the flight path (e.g., not complying with its flight path) or is otherwise at risk of near miss or collision, possibly due to other aircraft straying from their prescribed flight paths, a generated bubble around the visual indication of an aircraft may turn yellow or red (for example). In some examples, if the generated bubble turns yellow, then the aircraft has deviated slightly off plan (e.g., is not entirely compliant with flight path, is outside acceptable range of deviation or minimum compliance threshold). In some examples, if the generated bubble turns red, the aircraft has deviated far off plan (e.g., is not compliant with flight plan and is far outside acceptable range of deviation or minimum compliance threshold) and may place other aircraft in the airspace in danger of collision. The coordination system 312 can display the risks or lack of compliance during flying using the flight module 420. The generated indications of risk or lack of compliance to the flight path may be based on analyzing minimum separation of stay-out zones, such as spherical bubbles. A minimum separation threshold may be determined, which may be constant or may change based on aircraft direction, size, speed, weather, visibility, etc. The degree of violation of the minimum separation threshold may be used to determine the severity of the alert that is generated. There may be three levels of alerts, as described herein. In other embodiments, there may be two, four, five, or more levels of alerts.

At block 548, the coordination system 312 transmits the flight path that was approved to an air traffic monitor (e.g., air traffic monitor devices 306). The air traffic monitor, such as a human in an air traffic monitor tower at an airport or located remotely from the airport, may use the visual display generated in block 544 to monitor the aircraft. The air traffic monitor may, in response to seeing a risk indicator (such as a yellow or red bubble), communicate with the particular pilot to remedy the risk. Otherwise, for no risk indicators (such as green bubbles), the air traffic monitor need not actively guide, control, or communicate with such aircraft pilots, as those pilots are already safely following prescribed flight paths. At block 552, the user receives, via a visual tracking interface, a display showing the aircraft relative to the flight path and relative to other aircraft. The user may see the same or different representation as shown in block 544.

At block 560, a digital agent (e.g., digital agent 304, an AI agent) may be used to generate the flight path information. The digital agent may listen to the instructions from a user, pilot, or an operator. For example, the digital agent may listen to or hear the user explain how they would like to complete a flight path and receive information including the starting location, desired ending location, ground speed, ground distance, heading, starting altitude, vertical speed, and/or ending altitude. Additionally, the digital agent may listen to the instruction from the user that only includes a portion of information (e.g., desired ending location) and may generate the flight path using the available ADS-B data of the aircraft (e.g., aircraft identification information, GPS position, latitude, longitude, altitude, ground speed, vertical trend). A user may verbally input an intended path (e.g., “I plan to fly an average ground speed of 80 KTS while doing a gradual descent to 1000 feet from the current position and enter traffic pattern downwind. I will make a crosswind turn when 1 mile from the threshold and at 700 feet while flying an average ground speed of 80 KTS. Thereafter, I will enter Approach when aligned with the runway at 500 feet above ground level (AGL) and half-mile from the threshold. My approach will be at an average ground speed of 65 KTS”) and the digital agent will generate a flight path (e.g., block 123) for delivery to the coordination system 312.

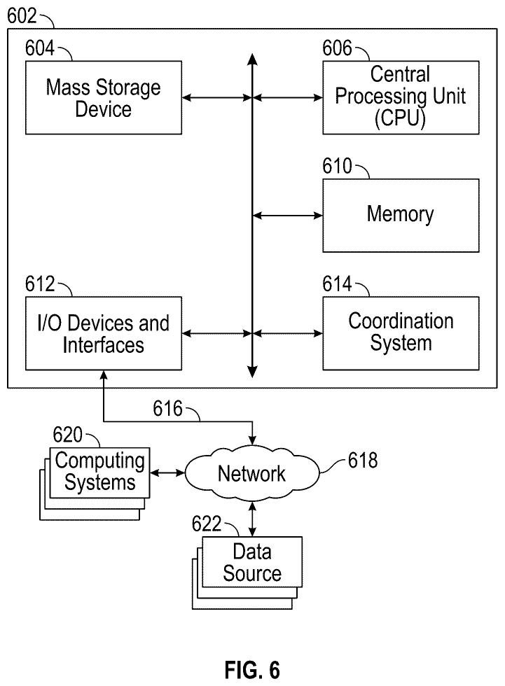

FIG. 6 illustrates a schematic of an embodiment of a computing system which may implement one or more components of the various geospatial systems described herein. The system may be a computer hardware system configured to run software for implementing one or more embodiments disclosed herein. The example computer system 602 is in communication with one or more computing systems 620 and/or one or more data sources 622 via one or more networks 618. While FIG. 6 illustrates an embodiment of a computing system 602, it is recognized that the functionality provided for in the components and modules of computer system 602 may be combined into fewer components and modules, or further separated into additional components and modules.

The computer system 602 can comprise a coordination system 614 that carries out the functions, methods, acts, and/or processes described herein. The coordination system 614 may be a programming module executed on the computer system 602 by a central processing unit 606.

The computer system 602 includes one or more processing units (CPU) 606. The computer system 602 further may include a physical memory 610, such as random-access memory (RAM) for temporary storage of information, a read-only memory (ROM) for permanent storage of information, a mass storage device 604, such as a backing store or hard drive, and/or one or more input devices 612.

The computer system 602 illustrated may be coupled to a network 618, such as a LAN, WAN, Radio, or the Internet via a communication link 616 (wired, wireless, radio or a combination thereof).

FIG. 7 is an embodiment of a graphical representation 700 of a planning mode that may be used by the various systems and methods described herein. The graphical representation 700, such as a graphical representation on a computing display screen, may be generated with the simulation module 416 of the coordination system 312. The graphical representation 700 can include a first flight segment 710 and a second flight segment 720 which may be input by the user (e.g., pilot). The graphical representation 700 may be shown in two dimensions but include three-dimensional data. In some examples, the user inputs two-dimensional plans. The user may input desired flight parameters (e.g., start location, end location, and middle point(s)). The graphical representation 700 can show the desired start 712 and end locations 722 of the aircraft (e.g., for takeoff or landing). The user or the system can then indicate altitude and time along each segment. In lieu of time, speed may be indicated.

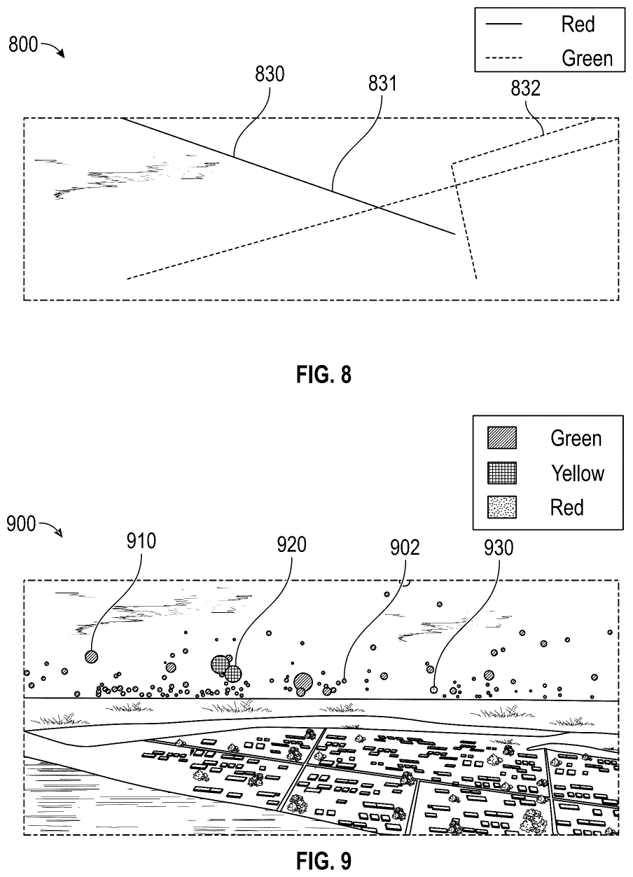

FIG. 8 illustrates a graphical representation 800 which may be generated with the simulation module 416 of the coordination system 312. The graphical representation 800 may show a three-dimensional flight plan or flight path 830 along with a time player (e.g. to allow user to simulate in past, present or future time). The flight path 830 may be differentiated from the other flight paths, such as by a red color or solid line (path 831), while the other flight paths are green or in dashed lines (path 832). Such indication may communicate that the aircraft is at risk of collision.

FIG. 9 illustrates a graphical representation 900 which may be generated with the flight module 420 of the coordination system 312. The graphical representation 900 may show one or more bubbles 902. The one or more bubbles 902 may be different colors based on the flight plan or flight path of the aircraft, as described. For example, the one or more bubbles 902 may be green or blue bubbles 910 (shown with diagonal shading in FIG. 9) if the aircraft is following the correct path or otherwise not at risk of near miss or collision. The one or more bubbles 902 may be yellow bubbles 920 (shown with crosshatching in FIG. 9) if the aircraft is slightly off path (e.g., has deviated away from the flight path beyond a margin of error, but can still be corrected without risking injury) or is at risk of near miss (either because it has deviated and/or another aircraft has deviated from its own flight path). The one or more bubbles 902 may be red bubbles 930 (shown with dotted shading in FIG. 9) if the aircraft is far off path (e.g., has deviated far away from the flight path beyond a maximum margin of error, and/or other aircraft have similarly severely deviated from their flight path, such that there is a risk of collision).

FIG. 10 illustrates a graphical representation 1000 of live traffic of airspace. The generated bubbles 1010 may be color-coded (e.g., green) to determine if there is a chance of a near-miss incident or collision, as described. Other indicators besides bubbles may be used. Other shapes may be used (e.g., cubes, cylinders, cones, pyramids, or prisms). Alerts may be visual and/or audible. The displays in FIGS. 9 and 10 may be shown on the screen of an air traffic monitor, such as at a tower of an airport or elsewhere. FIG. 11 is a visual display of an example user interface 1100 that may be used in the systems disclosed herein (e.g., the user interface of the pilot devices 302).

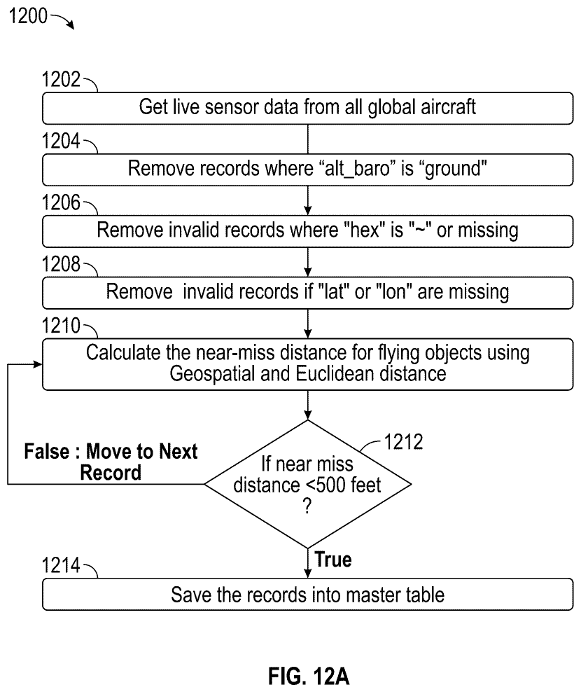

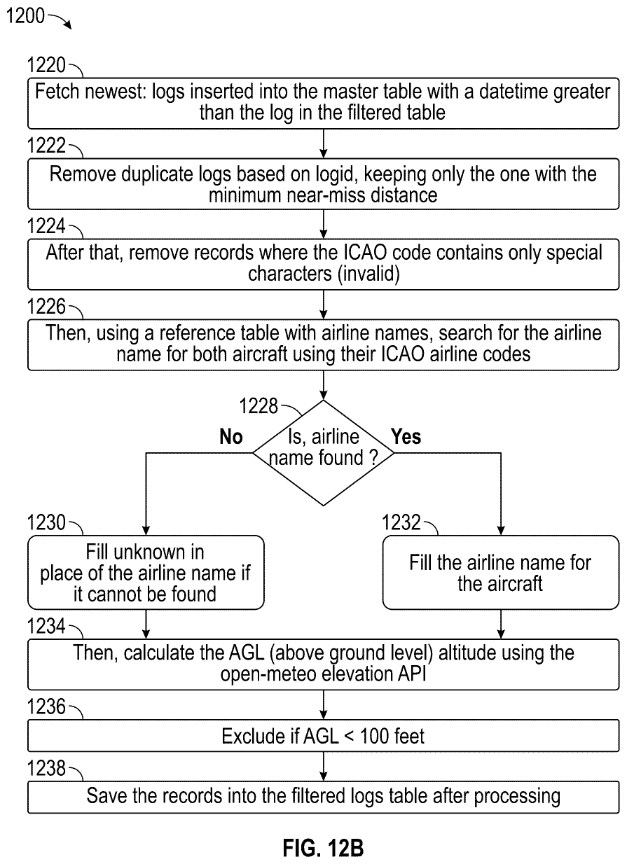

FIGS. 12A and 12B illustrate flow diagrams of example methods 1200 for identifying potential near-miss events between aircraft. The method 1200 may calculate three-dimensional distances between aircraft over time. The method 1200 can be used with other systems, methods, or flow charts described herein including, but not limited to, the aircraft avoidance system 100, the flight path 200, the aircraft zone 201, the second flight path 240, the third flight path 250, the system 300, and/or as otherwise shown in and described with respect to FIGS. 1A-11.

FIG. 12A shows a flow diagram of one example of the method 1200 for determining the distance between aircraft. At block 1202, sensor (e.g. ADS-B) data (e.g., technology that provides real-time tracking of aircraft positioning) may be acquired. At block 1204, aircraft that are determined to be at a ground level or not in the air may not be included in the records for determining the distance between aircraft. At block 1206, invalid records may be removed from the dataset that can be used to detect the distance between aircraft. At block 1208, records that fail to include certain geospatial information (e.g., latitude, longitude) may be removed from the records or the dataset that may be used to detect the distance between aircraft.

At block 1210, using the data gathered at block 1202 (and removed in blocks 1204, 1206, 1208) a near-miss distance may be calculated. The near-miss distance may be based on the geospatial and Euclidean distances between aircraft (e.g., aircraft in the aircraft zone 201). To determine the distance between the aircraft at block 1210, the aircraft avoidance system 100 may go through all of the flight records (e.g., data gathered at block 1202) and compare the distances between aircraft. Comparing the distance between aircraft may include calculating the horizontal distance between two or more aircraft (e.g., by using Geodesic-a Python library capable of determining the distance between multiple locations using latitude and longitude). Additionally, comparing the distance between multiple aircraft may include finding the difference in altitude (e.g., vertical difference) between the multiple aircraft (e.g., by subtracting the altitude of a first aircraft from the altitude of a second aircraft). Comparing the distance between multiple aircraft may also include (using the vertical difference and the horizontal distance) determining a diagonal distance between multiple aircraft.

At block 1212, the method 1200 may determine if the diagonal distance generated at block 1210 is less than a threshold, for example five hundred feet. If the diagonal distance is less than the threshold, then the method 1200 may determine that a near miss has occurred. If the diagonal distance is greater than the threshold, then the method 1200 may determine that a near miss has not occurred. At block 1212, the diagonal distance used to determine if a near-miss incident may vary and can be greater than or less than the threshold. For example, the diagonal distance may be two hundred feet, three hundred feet, four hundred feet, six hundred feet, seven hundred feet, and/or one thousand feet. At block 1214, the data (e.g., diagonal distance, near-miss incident) can be stored into a master dataset (e.g., table, spreadsheet).

FIG. 12B shows a flow diagram of another example of the method 1200 for determining the distance between aircraft with a filtered dataset including newer data (e.g., flight records and near miss incidents). At block 1220, logs are inserted into a master table that are at a different time (e.g., later day/time) than the logs in a filtered table. At block 1222, any logs that are duplicates are removed from the table. At block 1224, records are removed from the table that contain special characters. At block 1226, airline names are searched for based on the information from the logs included in the dataset. At block 1228, the system may determine if the airline name was found. If the airline name was not found, then an unknown is entered into a dataset (at block 1230). If the airline name was found, then the airline name is inserted into the table (at block 1232). At block 1234, an above ground measurement or level is determined (e.g., altitude) or generated. At block 1236, if the above ground level generated for the log is less than a threshold, such as 100 feet, the log may be removed from the dataset (filtered table). At block 1238, the records are saved to the filtered table. The methods 1200 of FIGS. 12A and 12B may be used in any of the methods described herein, such as for flight planning or monitoring aircraft, etc.

### Numbered Example Embodiments

The following are numbered example embodiments (NEE) of the technology described herein. This list is exemplary only and is not exhaustive.

NEE 1. An air traffic monitoring system comprising: a database configured to receive flight paths for multiple aircraft, wherein each flight path comprises a starting point, an ending point, and multiple segments connecting the starting point to the end point, with each segment identified temporally in four dimensions by latitude, longitude, altitude, and time; generate a stay-out zone for each moment in time for each aircraft along the respective flight path; compare the stay-out zones for the flight paths; determine the expected minimum distance between two or more of the stay-out zones; and generate indications of risk of collision based on the determined minimum distance.

NEE 2. A method of monitoring air traffic, the method comprising: receiving flight path for multiple aircraft, wherein each flight path comprises a starting point, an ending point, and multiple segments connecting the starting point to the end point, with each segment identified temporally in four dimensions by latitude, longitude, altitude, and time; generating a stay-out zone for each moment in time for each aircraft along the respective flight path; comparing the stay-out zones for the flight plans over time; determining the expected minimum distance between two or more of the stay-out zones; and generating indications of risk of collision based on the determined minimum distance.

NEE 3. A non-transitory computer-readable medium comprising instructions stored thereon that, when executed by one or more processors, causes the method of NEE 2.

NEE 4. The system, method or non-transitory computer-readable medium of any of NEEs 1-3, wherein the indications of risk comprise: a first level indication conveying the aircraft is following its prescribed flight plan within an acceptable margin of error and/or that the aircraft is not at risk of a near-miss with another aircraft; a second level risk indication conveying the aircraft has deviated from the prescribed flight plan beyond the acceptable margin of error but within a maximum allowable margin of error and/or that the aircraft is at risk of a near-miss with another aircraft; and a third level risk indication conveying that the aircraft is has deviated from the prescribed flight plan beyond the maximum allowable margin of error and/or that the aircraft is at risk of collision with another aircraft.

NEE 5. The system, method or non-transitory computer-readable medium of any of NEEs 1-4, where the indications of risk comprise visual displays.

NEE 6. The system, method or non-transitory computer-readable medium of NEE 5, where the visual display comprises a bubble surrounding the aircraft.

NEE 7. The system, method or non-transitory computer-readable medium of NEEs 5 or 6, where the visual display is color-coded.

NEE 8. The system, method or non-transitory computer-readable medium of any of NEEs 1-4, where the indications of risk comprise audible alerts.

NEE 9. A user device for use with an air traffic monitoring system, the user device comprising: one or more processors and one or more memories storing instructions thereon that, when executed by the one or more processors, causes a method of generating a four dimensional geospatial flight path, the method comprising: receiving user and/or flight data at the user device; generating a proposed flight path based on the user and/or flight data, the flight path comprising a four dimensional geospatial flight plan including latitude, longitude and altitude as a function of time; transmitting the proposed flight path to a coordination system of the air traffic monitoring system; and receiving a notification from the coordination system that the flight path was rejected or accepted.

NEE 10. The user device of NEE 9, wherein the method further comprises, in response to receiving the notification that the flight path was rejected, receiving second user and/or flight data at the user device and generating a new proposed flight path based on the second user and/or flight data.

NEE 11. The user device of NEE 9, wherein the method further comprises, in response to receiving the notification that the flight path was accepted, receiving a tracking of aircraft relative to the accepted flight path.

NEE 12. The user device of NEE 9, wherein the notification from the coordination system that the flight path was rejected or accepted is based on analysis of the four dimensional geospatial flight plan of the proposed flight plan path one or more other four dimensional geospatial flight plan(s) of one or more other aircraft.

NEE 13. A computing system for an air traffic monitor, the computing system comprising: one or more processors and one or more memories storing instructions thereon that, when executed by the one or more processors, causes a method of displaying indications of risk of aircraft collision, the method comprising: displaying one or more representations of one or more aircraft on a display; receiving data from a coordination system, the data comprising the indications of risk of collision for each of the one or more aircraft; and generating a respective alert associated with each aircraft's risk of collision.

NEE 14. The computing system of NEE 13, where the respective alert comprises a visual display.

NEE 15. The computing system of NEE 14, where the visual display comprises a color-coded indicator.

NEE 16. The computing system of NEE 15, where the indicator is green for low risk of collision, yellow for medium risk of collision, and red for high risk of collision.

NEE 17. The computing system of NEE 15, where the indicator is a bubble surrounding the respective aircraft.

NEE 18. The computing system of NEE 13, where the respective alert comprises an audible alert.

NEE 19. An air traffic monitoring system comprising: an air traffic monitor device; one or more memories storing instructions thereon; and one or more processors in communication with the air traffic monitor device and one or more memories, the one or more processors configured to execute the instructions to thereby cause the air traffic monitor device to: receive flight paths for multiple aircraft, wherein each flight path comprises a starting point, an ending point, and one or more segments connecting the starting point to the ending point, with each segment of the one or more segments identified temporally in four dimensions by latitude, longitude, altitude, and time; transmit the flight paths to a coordination system, the coordination system comprising a computational component configured to receive, process, and store data based on the flight paths; generate stay-out zones for each aircraft of the multiple aircraft along the respective flight path; compare the stay-out zones for the flight paths over time; determine an expected minimum distance between two or more of the stay-out zones; and generate indications of risk based on the expected minimum distance.

NEE 20. The air traffic monitoring system of NEE 19, wherein the indications of risk comprise visual displays.

NEE 21. The air traffic monitoring system of NEE 20, wherein the visual displays comprise a bubble surrounding the multiple aircraft.

NEE 22. The air traffic monitoring system of NEE 20, wherein the visual displays are color-coded.

NEE 23. The air traffic monitoring system of NEE 19, where the indications of risk comprise audible alerts.

NEE 24. The air traffic monitoring system of NEE 19, wherein the indications of risk are indications of risk of collision between multiple aircraft, wherein the indications of risk of collision are a first color when the expected minimum distance is above a first threshold, wherein the indications of risk of collision are a second color for medium risk when the expected minimum distance is below the first threshold and above a second threshold, and wherein the indications of risk of collision are a third color when the expected minimum distance is below the second threshold.

NEE 25. The air traffic monitoring system of NEE 19, further comprising generating indications of compliance to the flight paths, wherein generating indications of compliance comprises: a first level indication conveying an aircraft of the multiple aircraft is following a prescribed flight path within an acceptable margin of error or that the aircraft is not at risk of a near-miss with another aircraft; a second level risk indication conveying the aircraft has deviated from the prescribed flight path beyond the acceptable margin of error but within a maximum allowable margin of error or that the aircraft is at risk of a near-miss with another aircraft; and a third level risk indication conveying that the aircraft has deviated from the prescribed flight path beyond the maximum allowable margin of error or that the aircraft is at high risk of collision with another aircraft.

NEE 26. A method of monitoring air traffic, the method comprising: receiving flight paths for multiple aircraft, wherein each flight path comprises a starting point, an ending point, and multiple segments connecting the starting point to the ending point, with each segment identified temporally in four dimensions by latitude, longitude, altitude, and time; transmitting the flight paths to a coordination system, the coordination system comprising a computational component configured to receive, process, and store data based on the flight paths; generating stay-out zones for each aircraft along the respective flight path; comparing the stay-out zones for the flight paths over time; determining an expected minimum distance between two or more of the stay-out zones; and generating indications of risk based on the expected minimum distance.

NEE 27. The method of NEE 26, further comprising receiving the flight paths in a natural language.

NEE 28. The method of NEE 26, further comprising delivering the flight paths to an AI agent, the AI agent configured to generate and transmit flight path information to the coordination system.

NEE 29. The method of NEE 26, wherein the coordination system comprises a large language model (“LLM”).

NEE 30. The method of NEE 26, further comprising rejecting a flight path if the expected minimum separation between a respective aircraft and another aircraft of the multiple aircraft is below a minimum threshold.

NEE 31. The method of NEE 26, further comprising generating indications of compliance to the flight paths, wherein generating indications of compliance comprises: a first level indication conveying an aircraft of the multiple aircraft is following a prescribed flight path within an acceptable margin of error or that the aircraft is not at risk of a near-miss with another aircraft; a second level risk indication conveying the aircraft has deviated from the prescribed flight path beyond the acceptable margin of error but within a maximum allowable margin of error or that the aircraft is at risk of a near-miss with another aircraft; and a third level risk indication conveying that the aircraft has deviated from the prescribed flight path beyond the maximum allowable margin of error or that the aircraft is at high risk of collision with another aircraft.

NEE 32. The method of NEE 26, wherein the indications of risk comprise visual displays.

NEE 33. The method of NEE 32, wherein the visual displays comprise a bubble surrounding the multiple aircraft, wherein the bubble is color-coded.

NEE 34. The method of NEE 26, wherein the indications of risk comprise audible alerts.

NEE 35. A user device for use with an air traffic monitoring system, the user device comprising: one or more processors and one or more memories storing instructions thereon that, when executed by the one or more processors, causes a method of generating a four dimensional geospatial flight path, the method comprising: receiving flight data at the user device; generating a proposed flight path based on the flight data, the proposed flight path comprising the four dimensional geospatial flight path including latitude, longitude and altitude as a function of time; transmitting the proposed flight path to a coordination system of the air traffic monitoring system; and receiving a notification from the coordination system that the proposed flight path was rejected or accepted.

NEE 36. The user device of NEE 35, wherein the method further comprises, in response to receiving the notification that the proposed flight path was rejected, receiving second flight data at the user device and generating a new proposed flight path based on the second flight data.

NEE 37. The user device of NEE 35, wherein the method further comprises, in response to receiving the notification that the proposed flight path was accepted, receiving a tracking of aircraft relative to an accepted flight path.

NEE 38. The user device of NEE 35, wherein the notification from the coordination system that the proposed flight path was rejected or accepted is based on analysis of the four dimensional geospatial flight path of the proposed flight path and one or more other four dimensional geospatial flight paths of one or more other aircraft.

### Implementations and Language

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described may be incorporated in the example methods and processes. For example, one or more additional operations may be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems may generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications may be made without departing from the spirit and scope of the present invention. Moreover, the devices described herein need not feature all of the objects, advantages, features and aspects discussed above. Thus, for example, those of skill in the art will recognize that the invention may be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments may be combined with or substituted for one another in order to form varying modes of the discussed devices.

What is claimed is:

1. An air traffic monitoring system comprising:
an air traffic monitor device;
one or more memories storing instructions thereon; and
one or more processors in communication with the air traffic monitor device and one or more memories, the one or more processors configured to execute the instructions to thereby cause the air traffic monitor device to:
receive flight paths for multiple aircraft, wherein each flight path comprises a starting point, an ending point, and one or more segments connecting the starting point to the ending point, with each segment of the one or more segments identified temporally in four dimensions by latitude, longitude, altitude, and time;
transmit the flight paths to a coordination system, the coordination system comprising a computational component configured to receive, process, and store data based on the flight paths;
generate four-dimensional stay-out zones for each aircraft of the multiple aircraft along the respective flight path;
compare the four-dimensional stay-out zones for the flight paths over time;
determine an expected minimum separation between two or more of the four-dimensional stay-out zones; and
generate indications of risk based on the expected minimum separation.

2. The air traffic monitoring system of claim 1, wherein the indications of risk comprise visual displays.

3. The air traffic monitoring system of claim 2, wherein the visual displays comprise a bubble surrounding the multiple aircraft.

4. The air traffic monitoring system of claim 2, wherein the visual displays are color-coded.

5. The air traffic monitoring system of claim 1, where the indications of risk comprise audible alerts.

6. The air traffic monitoring system of claim 1, wherein the indications of risk are indications of risk of collision between multiple aircraft, wherein the indications of risk of collision are a first color when the expected minimum separation is above a first threshold, wherein the indications of risk are a second color for medium risk when the expected minimum separation is below the first threshold and above a second threshold, and wherein the indications of risk are a third color when the expected minimum separation is below the second threshold.

7. The air traffic monitoring system of claim 1, further comprising generating indications of compliance comprising:
a first level indication conveying an aircraft of the multiple aircraft is following a prescribed flight path within an acceptable margin of error;
a second level risk indication conveying the aircraft has deviated from the prescribed flight path beyond the acceptable margin of error but within a maximum allowable margin of error; and
a third level risk indication conveying that the aircraft has deviated from the prescribed flight path beyond the maximum allowable margin of error.

8. A method of monitoring air traffic, the method comprising:
receiving flight paths for multiple aircraft, wherein each flight path comprises a starting point, an ending point, and multiple segments connecting the starting point to the ending point, with each segment identified temporally in four dimensions by latitude, longitude, altitude, and time;
transmitting the flight paths to a coordination system, the coordination system comprising a computational component configured to receive, process, and store data based on the flight paths;
generating stay-out zones for each aircraft along the respective flight path;
comparing the stay-out zones for the flight paths over time;
determining an expected minimum separation between two or more of the stay-out zones; and
generating indications of risk based on the expected minimum separation.

9. The method of claim 8, further comprising receiving the flight paths in a natural language.

10. The method of claim 8, further comprising delivering the flight paths to an AI agent, the AI agent configured to generate and transmit flight path information to the coordination system.

11. The method of claim 8, wherein the coordination system comprises a large language model (“LLM”).

12. The method of claim 8, further comprising rejecting a flight path if the expected minimum separation between a respective aircraft and another aircraft of the multiple aircraft is below a minimum threshold.

13. The method of claim 8, further comprising generating indications of compliance to the flight paths, wherein generating indications of compliance comprises:
a first level indication conveying an aircraft of the multiple aircraft is following a prescribed flight path within an acceptable margin of error;
a second level risk indication conveying the aircraft has deviated from the prescribed flight path beyond the acceptable margin of error but within a maximum allowable margin of error; and
a third level risk indication conveying that the aircraft has deviated from the
prescribed flight path beyond the maximum allowable margin of error.

14. The method of claim 8, wherein the indications of risk comprise visual displays.

15. The method of claim 14, wherein the visual displays comprise a bubble surrounding the multiple aircraft, wherein the bubble is color-coded.

16. The method of claim 8, wherein the indications of risk comprise audible alerts.

17. A user device for use with an air traffic monitoring system, the user device comprising:
one or more processors and one or more memories storing instructions thereon that, when executed by the one or more processors, causes a method of generating a four dimensional geospatial flight path, the method comprising:
receiving flight data at the user device;
generating a proposed flight path based on the flight data, the proposed flight path comprising the four dimensional geospatial flight path including latitude, longitude and altitude as a function of time;
transmitting the proposed flight path to a coordination system of the air traffic monitoring system; and
receiving a notification from the coordination system that the proposed flight path was rejected or accepted.

18. The user device of claim 17, wherein the method further comprises, in response to receiving the notification that the proposed flight path was rejected, receiving second flight data at the user device and generating a new proposed flight path based on the second flight data.

19. The user device of claim 17, wherein the method further comprises, in response to receiving the notification that the proposed flight path was accepted, receiving a tracking of aircraft relative to an accepted flight path.

20. The user device of claim 17, wherein the notification from the coordination system that the proposed flight path was rejected or accepted is based on analysis of the four dimensional geospatial flight path of the proposed flight path and one or more other four dimensional geospatial flight paths of one or more other aircraft.
